(19) United States
(12) Patent Application Publication
(10) Pub. No.: US 2019/0046395 A1
(43) Pub. Date: Feb. 14, 2019

(54) MASSAGE DEVICE AND METHOD OF USE THEREOF

(71) Applicant: Raymond Thomas Routledge, Wynnum West (AU)

(72) Inventor: Raymond Thomas Routledge, Wynnum West (AU)

(21) Appl. No.: 16/100,267

(22) Filed: Aug. 10, 2018

(30) Foreign Application Priority Data
Aug. 11, 2017 (AU) 2017213573
May 17, 2018 (AU) 201812918

(51) Int. Cl. A61H 39/04; A61H 15/00

(52) U.S. Cl. CPC A61H 39/04; A61H 15/00; A61H 2205/081; A61H 2201/0119; A61H 2201/0157

(57) ABSTRACT

A massage device is disclosed comprising a base having a mounting surface and an opposed massage formation surface and first and second rows of massage formations extending along the base. The first and second rows of massage formations extend parallel to each other and are laterally spaced a distance apart from each other so that they engage muscle groups on either side of the vertebral column. Each of the first and second rows may conveniently have five to seven massage formations. The disclosure extends to a method of massaging a part of a person, e.g. their back, using the massage device.

### FIELD

This disclosure relates to a massage device for treating a part of a user's body. It also extends to a method of massaging using the massage device.

This disclosure relates particularly but not exclusively to a massage device for treating a back and a method of treating a back using the device. The device is particularly suitable for treating back pain, e.g. chronic back pain, but its application is much broader than this. It will therefore be convenient to hereinafter describe the disclosure with reference to this example application. However, at the same time, it must be recognized that the disclosure is capable of broader application. For example, the device is used for massaging other parts of the body such as the buttocks and legs. Further, it is not limited to the treatment of pain and can also be used for general massage, e.g. by sportsmen.

### DEFINITION

In the specification, the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

### BACKGROUND

Back pain is a common problem in populations around the world. Back pain can be caused by injury to skeletal structures and the reaction by the musculature around the skeletal structures. It is often exacerbated by excess body weight as the additional weight imposes an extra load on the skeleton and associated musculature. Applicant estimates that more than 30% of the population suffers from chronic back pain to the extent that it significantly impacts on their quality of life.

Back pain is often caused by muscle spasm which is the body's response to an injury and which causes intense pain and discomfort. Further, muscle soreness and/or tension related to stress is another cause of muscle pain and discomfort.

‘Trigger points’ are small contraction knots within muscles. These knots can sometimes cause increased muscle tightness and occasionally referred pain. Numerous causes of the development of trigger points have been suggested including acute muscular strain, falling, or repetitive micro-trauma possibly caused by excessive or unusual exercise.

One way to treat chronic muscle pain is to use medication that blocks the pain. However, this only provides temporary symptom relief and further medication needs to be taken at regular intervals. The medication has side effects and cannot be taken indefinitely and the efficacy of medication can also wear off over time. Thus, it will be readily appreciated that pain killers do not solve the underlying problem. The medication is a palliative at best and treat the symptom rather than the underlying problem.

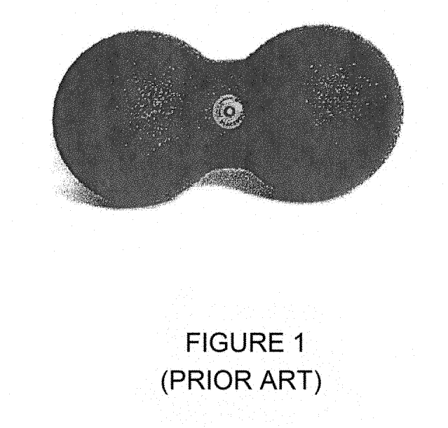

One prior art massage device that has been used to treat back pain is a double ball device illustrated in FIG. 1 of the drawings. In use, the double ball device is placed underneath a user's back and they move their body around on the ball. This has the effect of massaging a user's back at the point where the pressure of the double ball is applied. However, this ball device can be unstable when placed beneath a user having limited mobility or who is not very strong and fit and has a back injury and associated pain. It is therefore fundamentally unsuitable for use by many people suffering chronic back pain. Further, the ball device has had very limited success in treating back pain.

### SUMMARY OF THE DISCLOSURE

Applicant has recognized that it would be beneficial if a new and improved massage device could be developed for providing effective massage to stretch muscles after exercise and also to treat chronic pain, such as back pain.

According to one aspect of the disclosure, there is provided a massage device for massaging a user, the massage device comprising:
a base having a mounting surface and an opposed massage formation surface;
one row of massage formations projecting up from the massage formation surface extending along the base; and
a further row of massage formations projecting up from the massage formation surface extending along the base, wherein said one row and said further row of massage formations extend parallel to each other and are laterally spaced apart from each other at a distance suitable for engaging the erector spinae muscle groups on either side of the vertebral column of the user.

Each of said one row and said further row of massage formations may include from two to ten massage formations.

Each of said one row and said further row of massage formations may include from four to eight massage formations.

In particular each said one row and said further row may include from five to seven massage formations.

In a further refinement each said one row and said further row may have six massage formations.

The massage formations of each of said one row and said further row suitably have a base having a circular cross-sectional area having a center point.

The diameter of the circular cross sectional area may be from 25 to 40 mm.

The centers of the bases of adjacent massage formations in said one row may be spaced a distance of 70 to 80 mm apart from each other, e.g. about 74 to 76 mm.

The centers of adjacent massage formations in said further row may also be spaced a distance of 70 to 80 mm apart from each other, e.g. about 74 to 76 mm.

The massage formations of each of said one row and said further row may have a body extending from the base to a free end. The body may have a circular cross-sectional area having a central axis and a center. The circular cross-sectional area need not be constant along the body and suitably deceases from the base to the free end. In other words, the body can may include a tapered portion between the base and the free end.

Said one row and said further rows of massage formations may be arranged so that the distance between nearest or closest surfaces of the massage formations in each row is 30 to 80 mm. Optionally, the distance between nearest surfaces of the massage formations may be 30 to 50 mm, e.g. about 40 mm.

Said one row and said further row of massage formations are laterally spaced a distance apart from each other so in use when placed under a person's back the massage formations may engage the erector spinae muscles on each side of a user's vertebral column.

Conveniently centers of the massage formations in the one and further rows may be spaced a lateral distance of 70 to 80 mm apart from each other.

Applicant has found this matches the anatomy of the user which has two laterally spaced groups of erector spinae muscles running down each side of the spine.

Each massage formation may include:
a substantially cylindrical portion extending away from the base of the massage formation;
a rounded free end portion remote from the base and
a tapering portion extending between the cylindrical portion and the rounded free end portion.

By substantially cylindrical means that some degree of departure from the geometry of a right cylinder in which the cylinder walls are parallel to the base may be tolerated. For example, the cylinder may be oblique with angles between the walls and the base being between 40 to 60°.

The rounded free end portion may include a part spherical section having a radius of curvature of from 5 to 30 mm.

In one embodiment, the part spherical section may have a radius of curvature of 10 to 20 mm, e.g. 12 to 16 mm.

The extent of rounding of each of the free ends of the massage formation influences the massage action and massage force that is applied to the back muscles of a user. That is the surface of the massage formation that makes contact with a user's back may conveniently be sized and configured to apply the appropriate pressure to the user's back.

In another embodiment, each massage formation may include:
a frustoconical portion extending away from the base of the massage formation;
a free end portion remote from the base; and
a prolate spheroid portion extending away from the frustoconical portion between the frustoconical portion and the free end, the prolate spheroid portion having a major axis and a polar region, wherein the major axis of the prolate spheroid portion is co-axial with the center axis of the frustoconical portion and the free end portion is at the pole region of the prolate spheroid.

The frustoconical portion generally has a very gradual taper. For example, the opening angle of a complete cone corresponding to the frustoconical portion may be between about 1 to about 10°, suitably between about 2 to about 8°.

The polar axis of the prolate spheroid is co-axial with the center axis of the frustoconical section. The equatorial or minor axis of the prolate spheroid is suitably at or close to the junction between the frustoconical portion with the prolate spheroid portion. The equatorial axis may be the same or close to the radial axis of the end section of the frustoconical portion such that there is a smooth transition between the frustoconical part and the prolate spheroid part.

A working advantage of the prolate spheroid portion is that the shape at the free end, being the polar region, may closely mimic the shape of a thumb of a masseuse.

The free end of each massage formation extends in one aspect to a height of at least 20 mm above the massage formation surface and also above the base of the massage formation.

The free end of each massage formation extends to a height above the massage formation surface and also above the base of the massage formation, e.g. a height of 25 to 50 mm. The minimum height above the massage formation surface of the base provides the height or clearance to enable a person to move on the massage formations, e.g. to pivot from one side to the other. In one form the free end of each massage formation may extend up to a height of 35 mm above the massage formation surface.

Two or more of the massage formations in said one row of massage formations may be laterally aligned with associated massage formations in the further row of massage formations.

Additionally, said one row of massage formations may have the same number of massage formations as said further row of massage formations.

Each of the massage formations in said one row may be laterally aligned with its associated massage formation in the further row.

That is, the first massage formation in said one row may be laterally aligned with the first massage formation in said further row. The second massage formation in said one row may be laterally aligned with the second massage formation in said further row. This lateral alignment is repeated for all massage formations in each of said one and further rows of massage formations.

The base may be substantially planar to complement a support on which the device is mounted. Further, the support surface and the massage formation surface may be planar and extend substantially parallel to each other. Thus, the surfaces do not complement the natural curvature along a length of a user's spine. Thus, the massage device including both base and massage formations does not complement the natural curvature in a user's back along the cervical, lumbar and thoracic regions of a user's spine. This allows the pressure on the respective massage formations by the user to be varied with movement as discussed below.

Further, the base may have a low profile so as to provide space and room for a user to roll laterally from side to side without interference from the base. This feature is obviously interrelated with the height of the massage formations.

Suitably, the base has a profile of between about 5 mm to about 20 mm, suitably between about 10 mm and about 15 mm.

The base may be substantially rectangular with opposed end walls and opposed sidewalls. The base and may extend across said one and further rows of massage formations with a small clearance outward of each end of each row of massage formations and also outward of each side of each massage formation.

Thus, the base is sized and configured to receive said one row and said further row of massage formations with minimal clearance in a direction outward of the massage formations.

The base of the massage device may have an upper solid part that bears the upper massage formation surface and a lower structured part that forms the lower mounting surface.

In one embodiment, the lower structured part comprises at least one longitudinally support rib formation that extends between the end walls of the base and at least one laterally extending support rib formation extending between the side walls of the base.

Suitably the respective support rib formations extend continuously between the respective end walls and side walls of the rectangular base.

There may be one longitudinal support rib formation that extends along the longitudinal axis of the base.

There may be between one to nine, between three to eight, between four to seven, five or six lateral support rib formations.

The distance between the lateral support rib formations may be about the same distance as the distance between the centers of the massage formations.

The lateral support rib formations may be located midway between each massage support formation in each of the said one row and said further row.

Each massage formation may be hollow with an internal space with a bore that extends through the upper solid part of the base and communicates with a circular support wall having a circular support base.

The structured base may also further comprise a further longitudinal support formation that extends between the support walls associated with the massage formations of the said one row and/or said further row.

The structured base may further comprise further lateral support formations that extend laterally between each of the support walls associated with the massage formations of the laterally spaced support formation of the first and further rows.

Each of the respective further rib support formations may abut or join a circular support wall at a point corresponding to the central axis of the support wall.

A working advantage of the structured base is to provide a foot print of smaller cross section area that the area of the base as a whole. This increases the pressure at the support surface to provide additional grip on a support surface.

Still further, the circular support base associated with the support formations in use transmits the pressure placed by a user's body on the support formation to the support surface, thereby further griping the support surface.

In an embodiment in which the support formations may have a degree of flexibility, when pressure is applied to the massage formation by a user when the massage device is placed on a flat support surface such as a tiled floor a suction may be formed to still further engage the massage device with the support surface.

Still further, the spaced ribs may accommodate a surface such as a carpet or mat.

The base may be substantially rigid and have no flexibility or minimal flexibility. The massage formations may also be substantially rigid and have no flexibility or minimal flexibility, e.g. so as to apply maximum pressure to the muscles of a user.

The base and the massage formations may be integrally formed by means of molding, e.g. by injection molding of a polymeric material. A particularly suitable material is acrylonitrile butadiene styrene (ABS) that can have the necessary degree of rigidity whilst having some resilience due to the rubbery butadiene blocks in the polymer.

Another advantage of the hollow massage support formations and the structured base is that when injection molded, less material is required. This also reduces the weight of the massage device without compromising strength and/or rigidity.

Instead, the massage formations may have some resilience towards their free ends and may deform out of a resting position when pressure is applied thereto.

The disclosure extends to a device as defined in the preceding aspect of the disclosure when used for massaging a part of a person.

According to another aspect of the disclosure, there is provided a method of massaging a user's body, the method including:
placing a part of the user's body on a massage device as defined in a preceding aspect of the disclosure, with one or more of the massage formations bearing against the part of the user's body, to apply a pressure to the part of the user through the massage formations which effects a massage.

In the method, the part of the person's body may be their back.

The massage device may include any one or more of the optional or preferred features of the massage device described in the preceding aspect of the disclosure.

The massage device may be arranged with the said one and said further row of massage formations extending substantially parallel to the user's vertebral column and bearing against the erector spinae muscles on each side of the user's vertebral column.

With this arrangement, the massage formations may apply pressure to the part of the user's body that is a lumbar and/or thoracic region of a user's spine. Instead, the massage formations may apply pressure to the thoracic and/or cervical regions of the user's spine.

Further, instead of extending longitudinally, the massage device may be arranged so that the one and further rows of massage formations extend transversely to the user's vertebral column.

With this arrangement, the massage formations may apply pressure to the erector spinae muscles in the lumbar region of a user's spine and also to the muscle groups laterally outward thereof.

The method may further include the user moving on the massage formations so as to massage the part of the person's body.

Said moving on the massage formations may include rolling or pivoting the body on the massage formations from one side to the other.

That is, massaging a part of a user's body with the device may include lying on the massage device with the user's back bearing down on the device and moving on the device with a pivoting or rolling action to apply pressure to muscles in the back positioned above the massage device.

Lying on the massage device with the user's back bearing down on the device may include positioning one end of the base proximate the lumbar region of the spine and the other end of the base proximate to the thoracic region of the spine.

Instead, moving on the massage formations may include to- and fro-movement in the longitudinal direction of the user's body.

Further in the method, the part of the person's body being massaged may be the buttocks, the upper legs, and the shoulders.

The method may include increasing or decreasing the pressure applied by the massage formations to the user's muscles by raising or lowering the user's arms while the user is lying on the device. The user's arms may begin in a resting position in a horizontal plane parallel to the user's torso before being raised to a position perpendicular to the user's torso in the vertical direction. The resting position may be one where the arms of the user are extended above the head of the user, one where the user's arms are extended by the side of the user or one where the user's arms are extended perpendicular to the torso in the horizontal position.

The massaging may also include increasing or decreasing the pressure applied by the massage formations to the user's muscles by raising or lowering the user's feet off the ground and optionally also bending or extending the knees of the user.

The method may include increasing or decreasing the pressure applied to the user's muscles by increasing or decreasing the number of massage formations used by the user. The amount of pressure applied to the user's muscles may be controlled by distributing the user's body weight onto a larger number or smaller number of the massage formations.

At least one embodiment in accordance with the disclosure provides an effective massage device and method of massaging with the device for effectively treating chronic back pain and avoiding the side effects of medication.

One feature of the device in accordance with this disclosure is that it is used by a user to massage their body themselves. The massage is not typically applied by another person. Further, it cleverly uses the weight of a user's body to generate the pressure to apply a deep massage to the muscles of the user.

### DETAILED DESCRIPTION

A massage device in accordance with this disclosure may manifest itself in a variety of forms. It will be convenient to hereinafter describe at least one embodiment of the disclosure in detail with reference to the accompanying drawings. The purpose of providing this detailed description is to instruct persons having an interest in the subject matter of the disclosure how to carry it into practical effect. However, it is to be clearly understood that the specific nature of this detailed description does not supersede the generality of the preceding broad description. In the drawings:

FIG. 1 is a perspective view of a massage device used for massaging a user's back in accordance with the prior art;

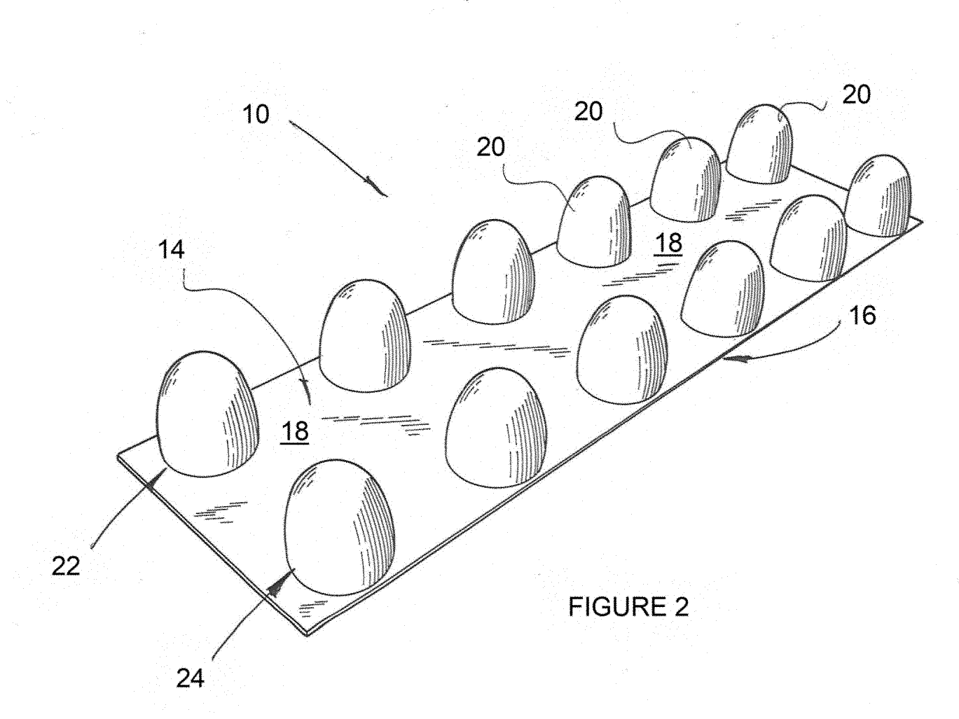

FIG. 2 is an upper perspective view of one embodiment of a massage device in accordance with the disclosure;

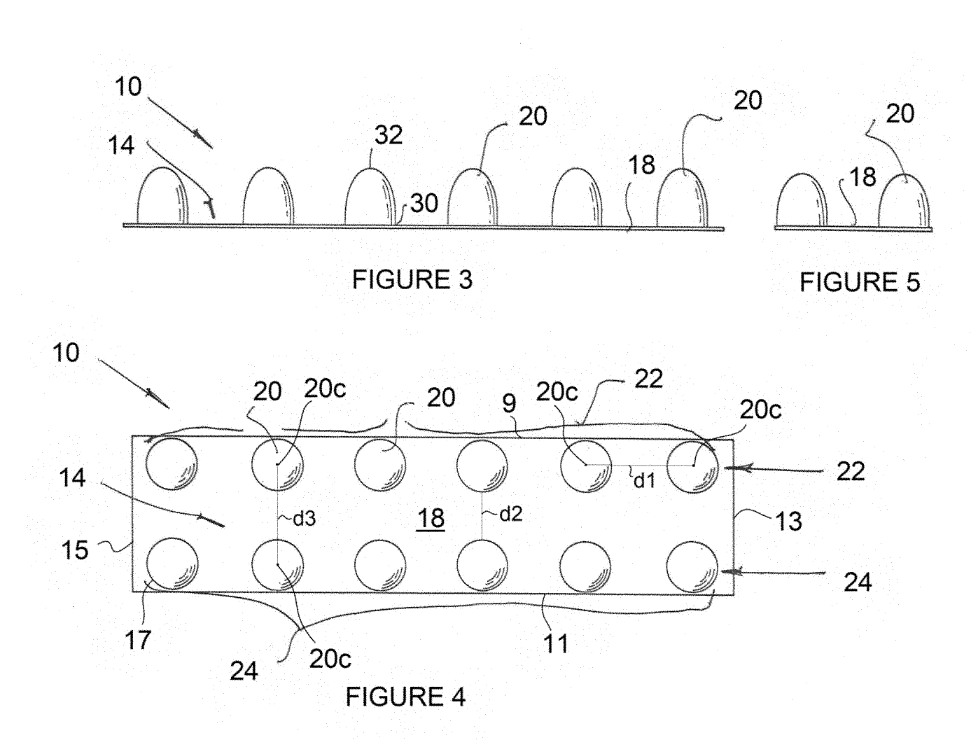

FIG. 3 is a front view of the massage device of FIG. 2;

FIG. 4 is a top plan view of the massage device of FIG. 2;

FIG. 5 is an end view of the massage device of FIG. 2;

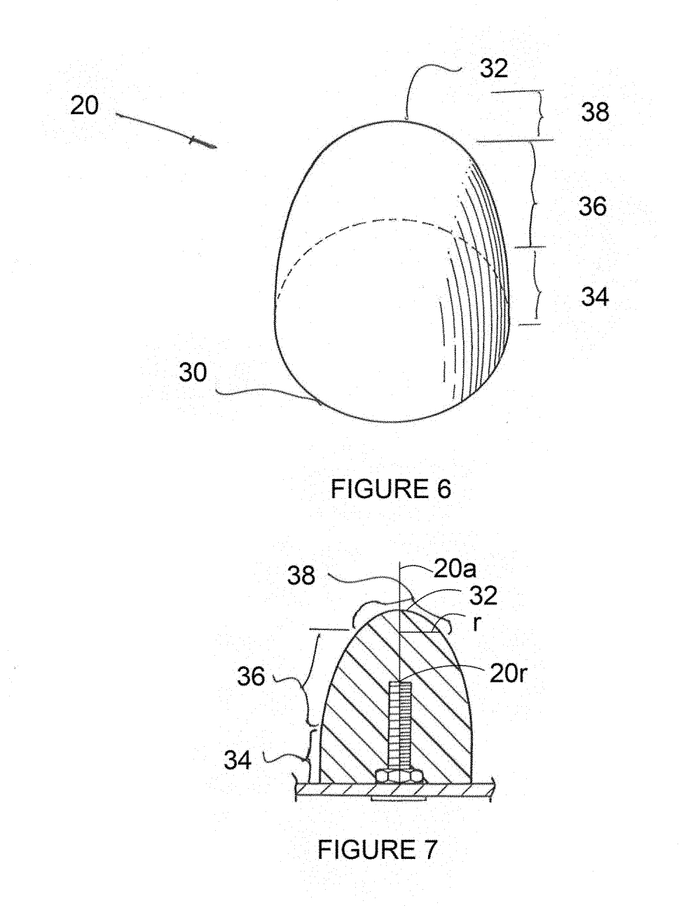

FIG. 6 is a close up perspective view of a massage formation of the massage device shown in the preceding drawings;

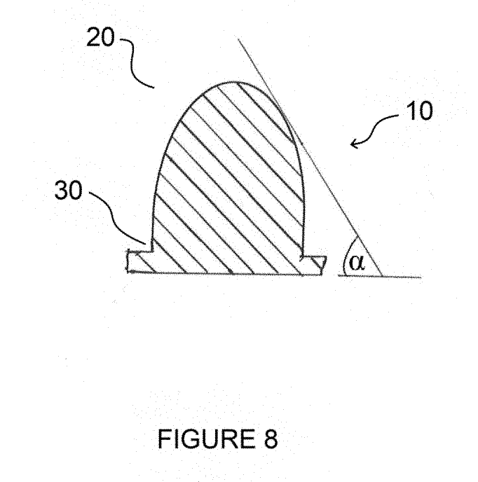

FIG. 7 is a cross-sectional front view of the massage formation of FIG. 6;

FIG. 8 is a cross-sectional front view of a massage formation for a massage device that is a variation on that shown in FIGS. 2 to 6;

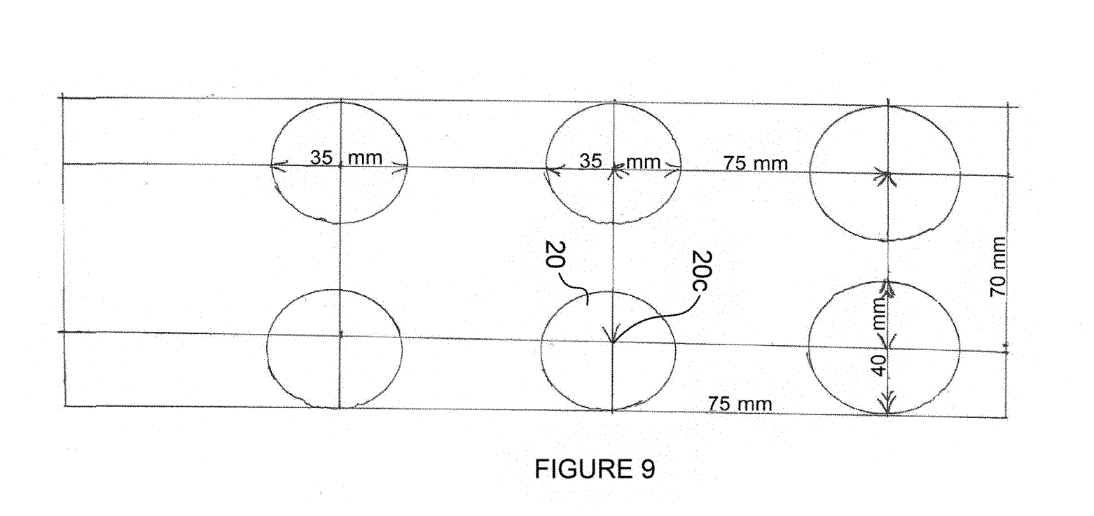

FIG. 9 is a plan view of a massage device that is a variation on that shown in FIG. 2;

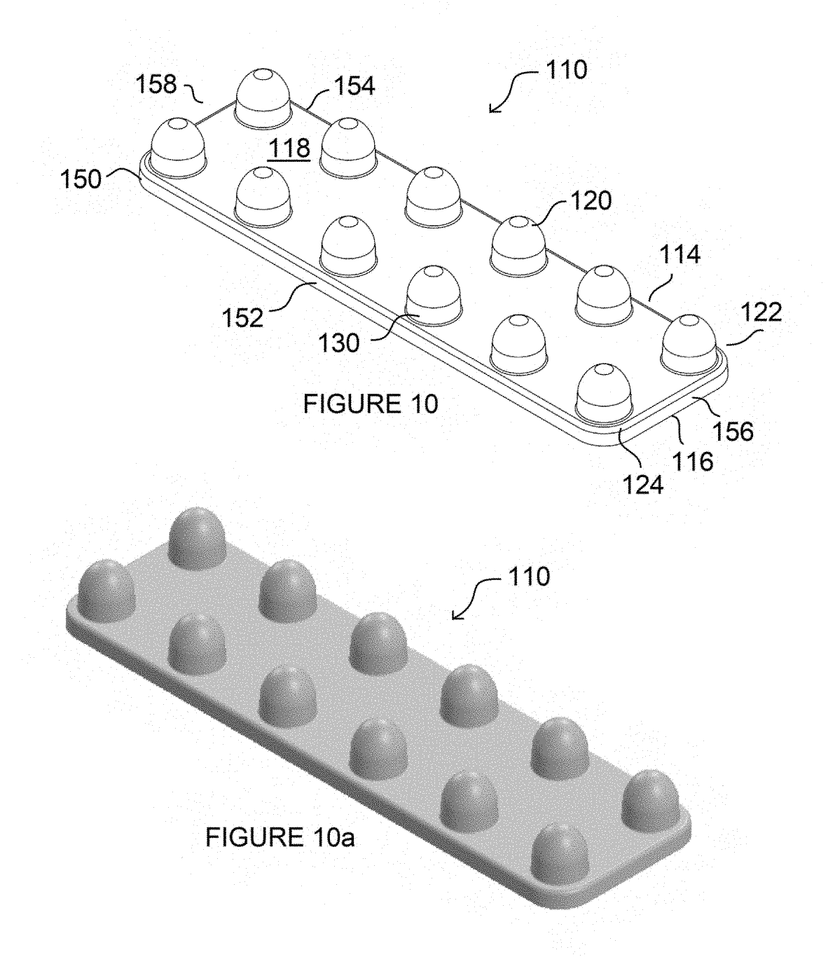

FIG. 10 is a top perspective view of a massage device that is a variation on that shown in FIG. 2;

FIG. 10A is the same view as shown in FIG. 10 in rendered form;

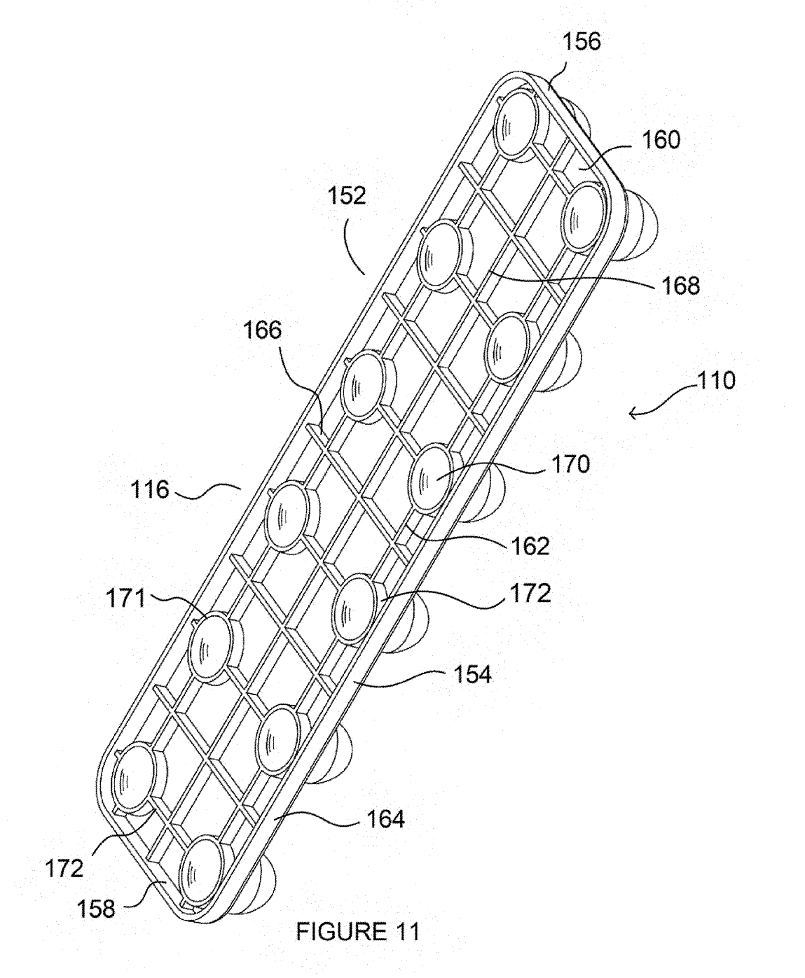

FIG. 11 is a bottom top perspective view of a massage device that is shown in FIG. 10;

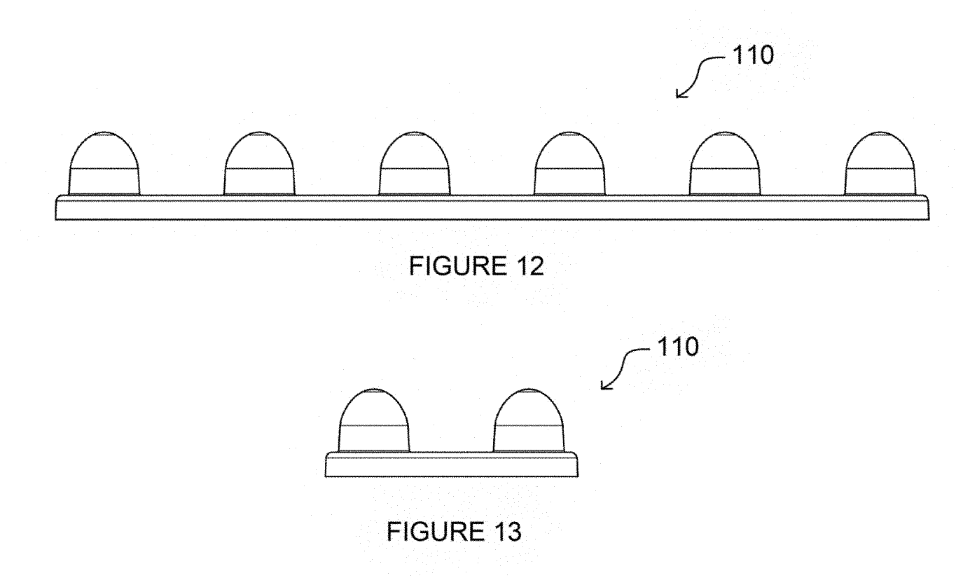

FIG. 12 is a front view of a massage device that is shown in FIG. 10;

FIG. 13 is an end view of a massage device that is shown in FIG. 10;

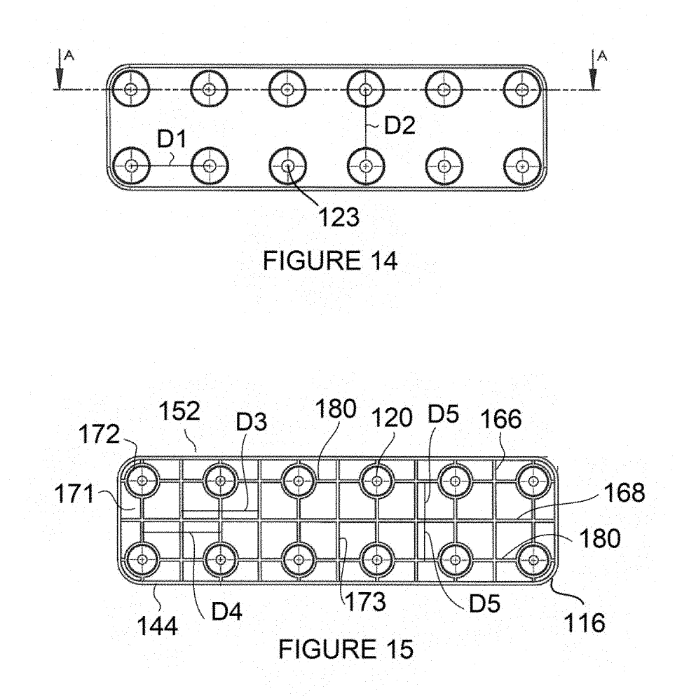

FIG. 14 is a top plan view of a massage device that is shown in FIG. 10;

FIG. 15 is a bottom view of a massage device that is shown in FIG. 10;

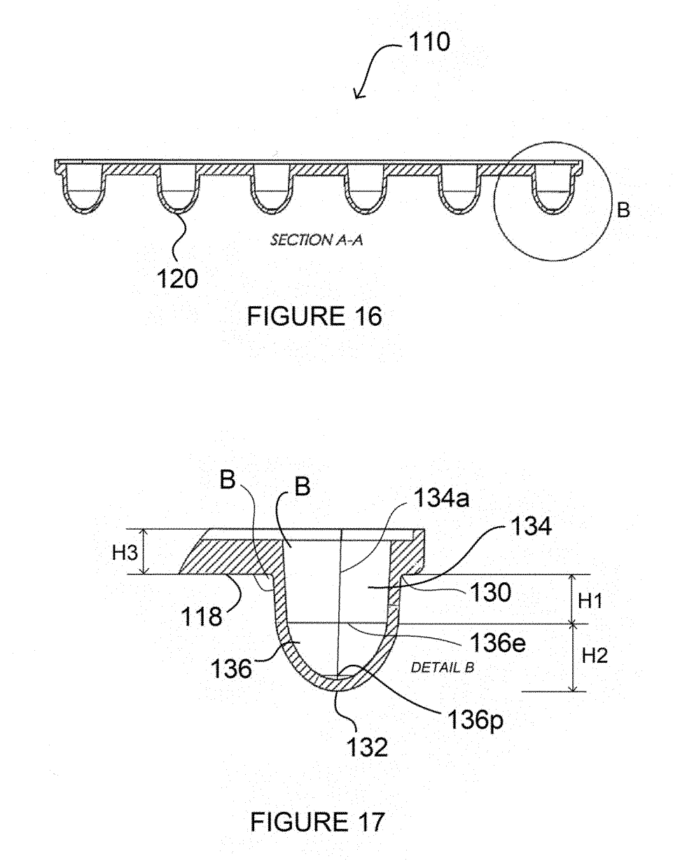

FIG. 16 is a cross section through A-A of the massage device as shown in FIG. 14;

FIG. 17 is a detail B of the cross section of a massage formation of a massage device as shown in FIG. 16;

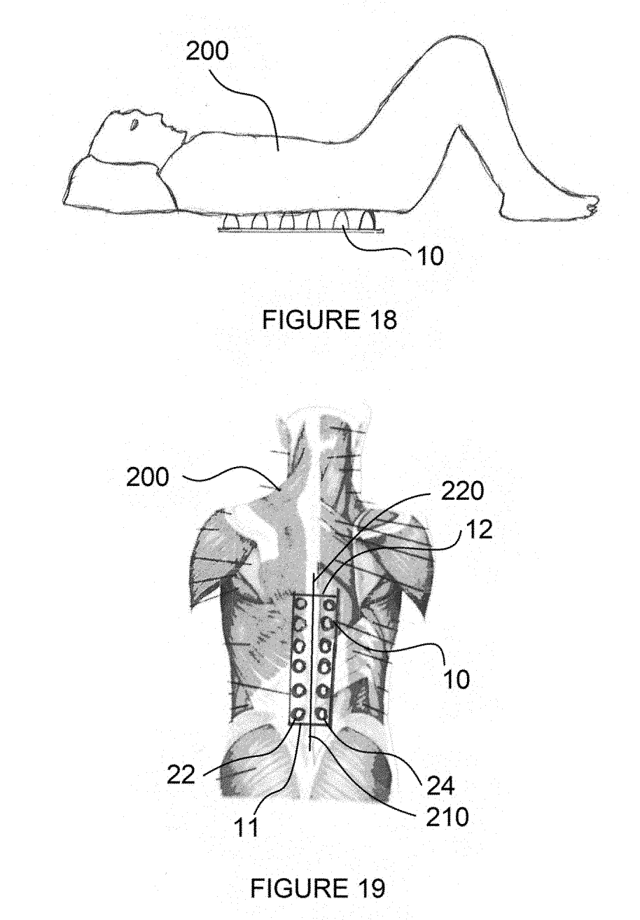

FIG. 18 is a schematic side view of a person using the massage device with the device positioned beneath a user's back to massage the muscles on either side of their vertebral column;

FIG. 19 is a schematic bottom plan view showing a person's vertebral column and associated muscle groups and the massage device positioned relative to the person's back;

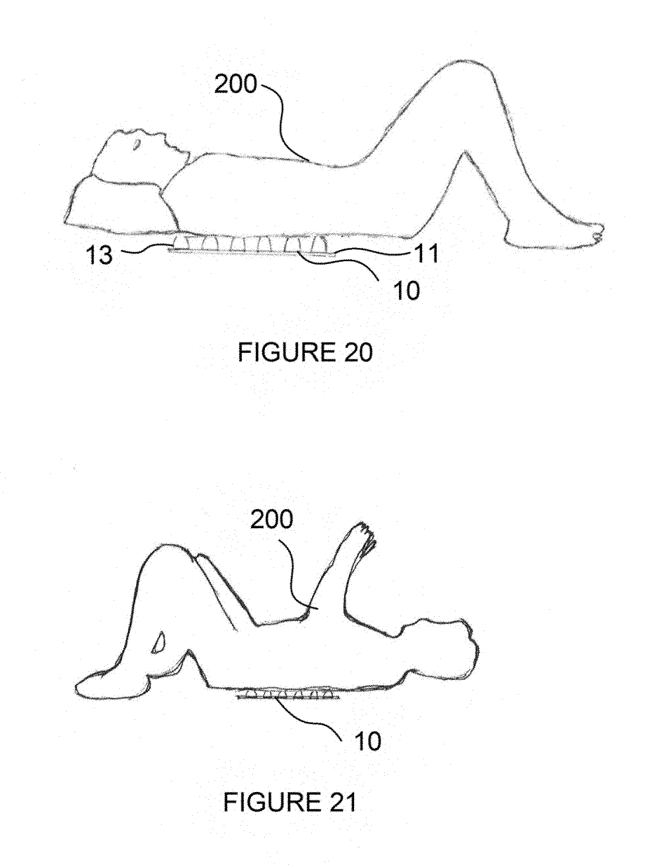

FIG. 20 is a schematic side view of a person using the massage device with the device positioned higher up the person's back than in FIG. 18;

FIG. 21 is a schematic side view of a person using the massage device with their arms raised and angled back towards their head;

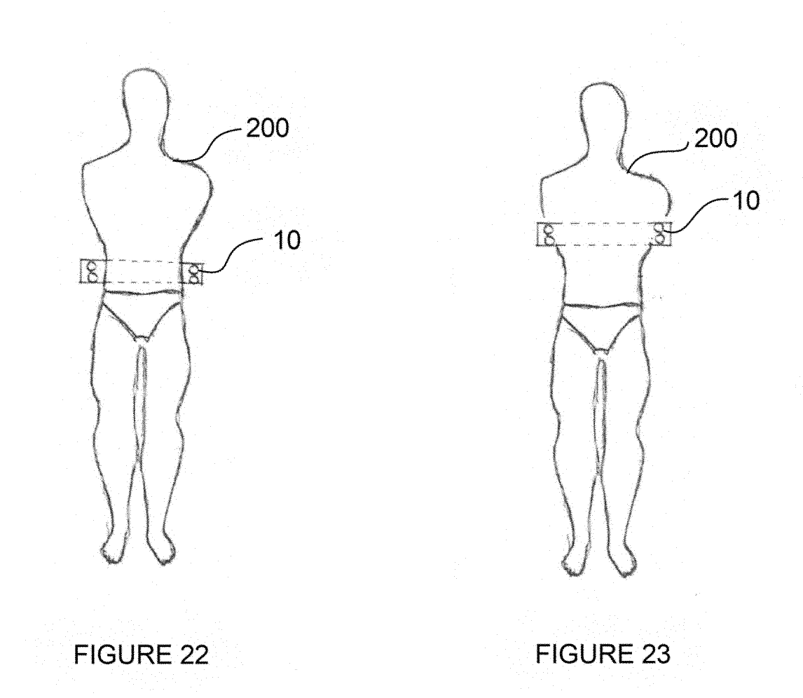

FIG. 22 is a schematic side view of a person using the massage device with the device extending transverse to their vertebral column;

FIG. 23 is a schematic side view of a person using a transverse extending massage device, with the device shown in a different position to FIG. 22;

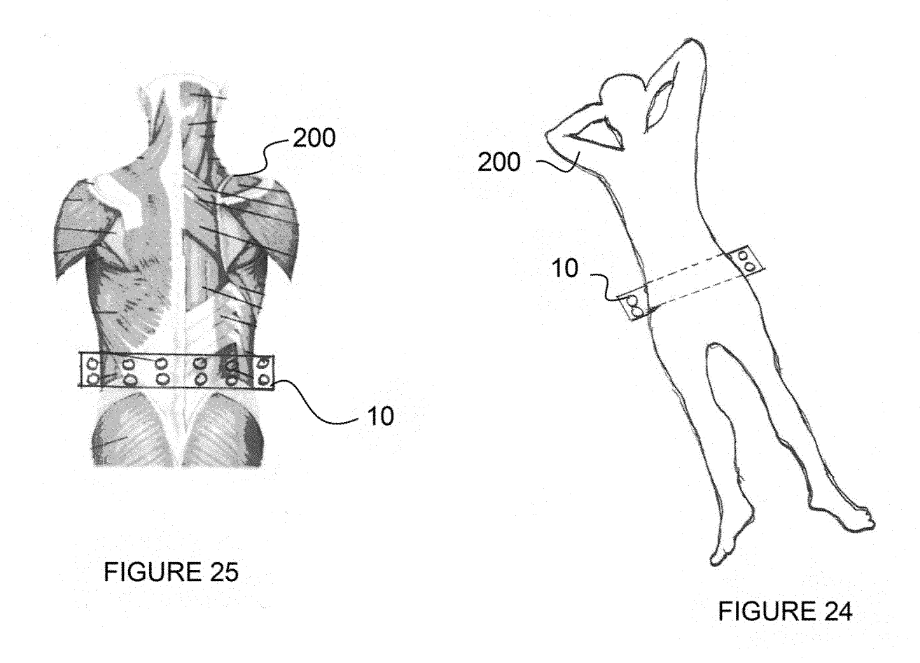

FIG. 24 is a schematic perspective view of a person using a transverse extending massage device with their arms raised up and their hands behind their head;

FIG. 25 is a schematic bottom plan view showing a person's vertebral column and associated muscle groups relative to a transverse extending device;

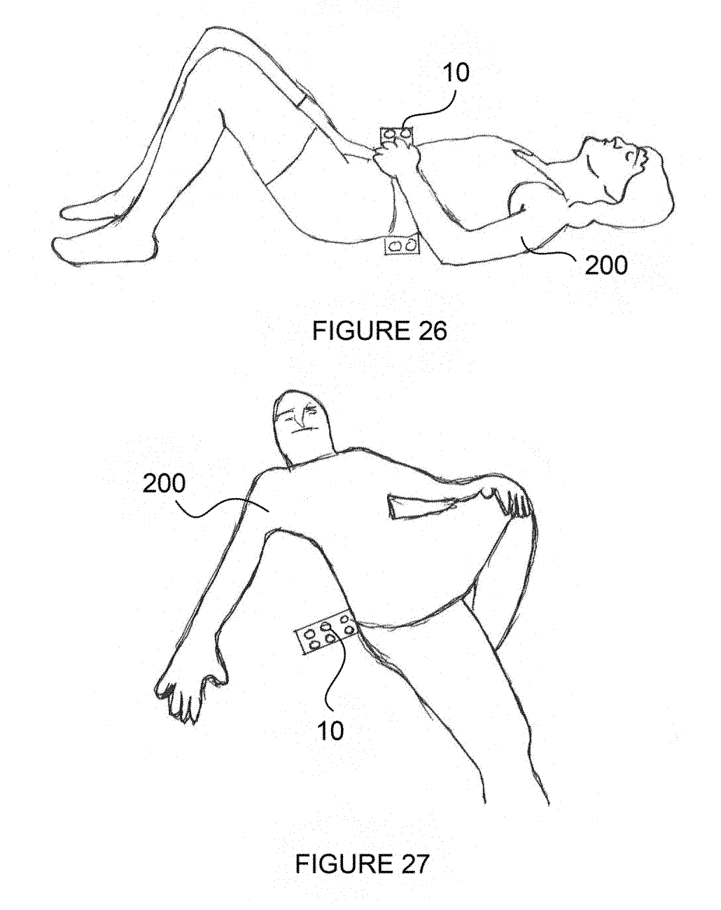

FIG. 26 is a schematic perspective view of a person using a transverse extending the massage device with the person rolling from one side to the other while massaging the device; and

FIG. 27 is a schematic perspective view of a person using the massage device with the device extending transverse to their vertebral column with the person rolling their lower body to one side.

FIG. 1 illustrates a prior art arrangement and has been discussed in the background section above. This arrangement will not be discussed further in the detailed description below.

In FIG. 2, reference numeral 10 refers generally to a massage device in accordance with one embodiment the disclosure.

The massage device 10 comprises broadly a substantially planar base 14 having an operatively lower mounting surface 16 and an opposed operatively upper massage formation surface 18.

The device 10 further has a first row 22 of massage formations 20 extending in a line along the base 14, and a second row 24 of massage formations 20 extending in a further or second line along the base 14. The first and second rows of massage formations 22 and 24 extend parallel to each other. Each of said first and second rows 22 and 24 of massage formations has from five to seven spaced massage formations 20 along their length. In one example embodiment shown in the drawings, the first and second rows 22 and 24 have six massage formations 20 along their length and this embodiment has been found to be particularly effective for treatment.

Each massage formation includes a base 30 mounted on the massage formation surface 18 and a free end 32 spaced from the base 30. Each massage formation 20 has a diameter of 30 to 40 mm adjacent its base. In the example embodiment illustrated in the drawings, each massage formation 20 has a diameter of 33 to 36 mm at its base.

Each massage formation 20 in the first 22 and second 24 rows of massage formations has a circular cross-sectional area and a central axis 20a with a center 20c (as shown in FIG. 7).

As shown in FIG. 4, the central axes 20a or centers 20c of the longitudinally adjacent massage formations 20 in each row 22 and 24 of massage formations are spaced a distance d1 of 70 to 80 mm apart from each other. In the example embodiment illustrated in the drawings, the centers of adjacent massage formations 20 are spaced a distance of 74 to 76 mm apart from each other.

Correspondingly, the first 22 and second 24 rows of massage formations 20 may be sized and arranged so that the closest or nearest distance d2 between surfaces of longitudinally adjacent massage formations is 30 to 50 mm. In the example shown in the drawings, the distance d3 between closest surfaces of adjacent massage formations is about 40 mm. If the massage formations 20 are slightly larger in diameter, then this spacing will be a correspondingly smaller distance. This is shown in the device on FIG. 9 which shows massage formations 20 having two sizes of massage formations.

The first and second rows of massage formations 22 and 24 are laterally spaced a suitable distance apart from each other so that they engage the erector spinae muscles groups on each side of the vertebral column. Conveniently, centers of the massage formations 20 in the two rows may be spaced a lateral distance d3 of 70 to 80 mm apart from each other. In the illustrated spaced embodiment, the centers are about 75 mm apart from each other. Applicant has found this matches the anatomy of most users who have two laterally spaced groups of erector spinae muscles running down each side of the spine.

Each massage formation 20 has a specific configuration as shown in the drawings and in particular FIGS. 5 and 6. The massage formation 20 includes three portions extending in a direction away from its base 30 to its free end 32. The first portion is a cylindrical portion 34 extending away from the base 30. The second portion 36 is a tapering portion extending away from the cylindrical portion 34 towards the free end 32. The third portion is a rounded end portion 38 remote from the base 30.

We now discuss the rounded end portion 38 in more detail. The rounded end portion 38 includes a rounded surface having a part spherical section having a radius of curvature r of 10 to 20 mm. In the example illustrated in the drawings, the part spherical section has a radius of curvature r of 12 to 16 mm. The extent of rounding of each of the free ends of the massage formation influences the massage action that is applied to the back muscles of a user. The surface of the massage formation that makes contact with a user's back needs to be suitably sized so as to apply the appropriate pressure to the user's back. If the area is too large then the pressure applied to the muscles is too low for efficacious treatment.

Each massage formation 20 has its free end positioned at a height of 30 to 60 mm above the massage formation surface 18 and the base 30 of the massage formation 20. Suitably each massage formation extends to a height of 40 to 50 mm above the massage formation surface 18. In the illustrated embodiment, the massage formations 20 extend up to a height of 45 mm above the massage formation surface 18. Typically the massage formations would all be the same height above the base. It is important that the free end of the massage formations is at a sufficient height above the base to enable the user to roll or pivot from side to side on the device.

The individual massage formations 20 in the first row of formations 22 are laterally aligned with their corresponding formations in the second row of formations 24 and have the same height. That is, the first massage formation 20 in the first row 22 is laterally aligned with the first massage formation 20 in the second row 24 and is the same height. Similarly, the second massage formation 20 in the first row 22 is laterally aligned with the second massage formation 20 in the second row 24. This lateral alignment of massage formations 20 in the first and second rows 22 and 24 is repeated for all succeeding massage formations 20 in the first and second rows. In addition to individual massage formations being laterally aligned, the first and second rows have the same overall number of massage formations 20. That is, the first and second rows are alike in all material respects.

The planar base 14 has a planar support surface or lower mounting surface 16 to complement the support surface such as the floor on which the device 10 is placed. The support surface 16 and the massage formation surface 18 are substantially parallel to each other and thus the massage device generally does not complement the natural curvature in a user's back.

Conveniently the base 14 may be sized and configured to have little or no surround 18 outside of said first and second rows of massage formations 22 and 24. The base 14 has a substantially rectangular configuration having two ends and two sides and provides a small peripheral margin around the massage formations 20. That is, the base 14 is sized to provide a minimal clearance at each end of each row 22, 24 of massage formations and also along each side of each row 22, 24 of massage formations.

The base 14 is substantially rigid and has little or no flexibility. Similarly, the massage formations 20 may be substantially rigid. Optionally, the massage device 10 including the base 14 and the massage formations 20 is integrally formed. In one form, the base and the massage formations are integrally molded from a polymeric material by an injection molding process. However, in other embodiments, the massage formations 20 have some resilience towards their free ends 32 and may be deformed out of a resting position when pressure is applied thereto.

In use, the massage device 10 is used to massage the body of a user. Typically, the massage device 10 is used to massage the back of a user but it may also be used to massage other areas of the body of a user such as buttocks, legs and shoulders.

The device 10 is arranged with the rectangular base 14 extending lengthwise along the users back parallel to their vertebral column. The user lies on the massage device with the device positioned beneath their back on a support surface such as the floor. The first and second rows of massage formations 22 and 24 are arranged to bear against the erector spinae muscle groups closely spaced on either side of the user's vertebral column.

The device 10 can be used to massage the erector spinae muscles that extend the length of the spine on each side of the spine. The device 10 can be used to massage the trapezius muscles, rhomboid muscles and the cervical extensor muscles in the upper body of the user. Further, the device 10 can be used to massage one or more groups of cervical muscles, thoracic muscles or lumbar muscles of the user.

The device 10 can also be used to massage muscles in the lower body of the user, for example, the gluteus maximus and medius muscles, and the hamstring muscles extending along the upper leg.

FIG. 8 shows an embodiment of a massage device 10 in accordance with another embodiment of the disclosure. It is very similar to the embodiment described above and, unless otherwise indicated, the same reference numerals will be used to refer to the same components. Further, the following description will focus on the main differences between this embodiment and the earlier embodiment.

In this embodiment, the base 14 and the massage formations 20 are integrally formed of the same material, e.g. a polymeric material, by injection molding. Thus, the rigidity of the massage formations in this embodiment will be the same as that of the base. A tangent line extending from the support up to the free end of the massage formations may extend at an angle α of 70 degrees to 110 degrees to the base.

FIG. 9 shows a variation on the embodiment of FIG. 2 and shows some dimensions of the spacing between the massage formations 20. This device has a different arrangement of massage formations and also has different sizes of massage formations.

FIGS. 10 to 17 show another embodiment of a massage device 110. The massage device 110 is similar to that shown in FIG. 2 in comprising broadly a substantially planar base 114 having an operatively lower mounting surface 116 and an opposed operatively upper massage formation surface 118.

The planar base 114 is a rounded rectangle and the radius of curvature of each rounded corner 150 is 22 mm. The planar base 114 has two side walls 152, 154 and two end walls 156, 158.

The device 110 also has first 122 and second 124 parallel rows of massage formations 120. Each row 122, 124 of massage formations 120 has six massage formations 120 along their length.

The massage device 110 is injection molded in a single piece from acrylonitrile butadiene styrene (ABS). ABS is particularly suitable for use in view of its combination of rigid styrene blocks and rubbery butadiene blocks. ABS is hard wearing and resistant to water that makes it easy to clean and is durable.

The base 130 of each massage formation 120 where it joins the upper massage formation surface 118 has a diameter of 35 mm.

The central axes or centers 123 of the longitudinally adjacent massage formations 120 in each row 122 and 24 of massage formations are spaced a distance D1 of 75 mm apart from each other.

The first and second rows of massage formations 122 and 124 are also laterally spaced at a distance D2 of 75 mm apart from each other so that in use they may overlie the erector spinae muscles groups on each side of the vertebral column.

FIGS. 11 and 15 show the operatively lower mounting surface 116 that in use is supported by a support surface such as a floor.

The base 114 has a solid upper part 160 that bears the upper massage formation surface 118 and a lower structured part 162 that bears the lower mounting surface 116.

The base 114 has an outer perimeter wall 164 that defines the side 152, 154 and end walls 156, 158.

The lower structured part 162 of the base 116 has a first set of five lateral support ribs 166 that extend continuously and equally spaced apart at a distance D3 of 75 mm and connecting the opposed side walls 152, 154.

There is also a single continuous and uninterrupted longitudinal rib 168 extending centrally between each end wall 156, 158.

The massage formations 120 extend through base 116 and terminate in open circular wall 172 with a circular support base 171 that form part of the mounting surface 116. The massage formations 120 have a hollow body 170.

The mounting surface 116 further comprises six lateral ribs 173 that are each interrupted by and joined to the circular support base 171 associated with a massage formation 120 of each row 122, 124. The lateral ribs 173 are spaced a distance D4 of 75 mm apart.

Likewise, there are two further longitudinal ribs 180 extend along the length of each row 122, 144. Each rib 180 is each interrupted by and joined to the circular support base 171 associated with of a massage formation 120 of respective row 122, 124.

Each lateral and longitudinal ribs interconnect together.

The respective ribs are each joined to the circular support wall 172 co-axial with the major axis of the circle.

The interconnecting ribs and feet provide a strong supporting structure for the device.

The thickness of the walls of the hollow body of the massage formations 120 and the ribs are each 2 to 5 mm, suitable 3 mm. The thickness of the upper solid part of the base has a thickness of 7 to 12 mm, suitably 9 mm so as to provide the necessary rigidity to the massage device 110.

FIGS. 11 and 15 show that the ribs and feet form a grid pattern that provides for uniform weight distribution. Also, the reduced surface area of the ribs and fit facilitate degree of grip on the support surface, especially during use as described below.

Each massage formation 120 has a specific configuration as shown in the drawings and in particular FIG. 17. The massage formation 120 has a free end 132 and base 130.

Each massage formation includes two major portions extending in a direction away from its base 130 to its free end 132. The first portion is a frustoconical portion 134 extending away from the base 130 with a vertical height of 1284 mm.

The opening angle of the complete cone of the frustoconical portion is 6°. The angle β is 44° thereby providing a small taper.

The second portion 136 is a partial prolate spheroid with a polar radius of about 19 mm and an equatorial radius of about 16 mm.

The polar axis of the prolate spheroid is with the center axis of the frustoconical section. The equatorial axis of the prolate spheroid is suitably at or close to the junction with the frustoconical portion with the prolate spheroid. The equatorial axis may be the same or close to the radial axis of the terminating section of the frustoconical part such that there is a smooth transition between the frustoconical part and the prolate spheroid part.

The height of the free end 132 from the upper massage formation surface 118 is 31 mm.

The profile of the massage formations 120 are designed to simulate that of a human thumb so as to simulate the thumbs of a masseuse.

FIGS. 18 to 27 show the massage device in use.

FIGS. 18 and 19 show a person 200 using the massage device 10 with the device 10 positioned beneath a user's back. The longitudinal axis of the device extends parallel to the user's vertebral column.

As shown in the drawings, the two rows of massage formations 22, 24 line up and bear against the erector spinae muscles extending along each side of the vertebral column spaced a short distance away from the vertebral column. One end 11 of the device 10 is positioned in a lower lumber region of the spine and the other end 13 is positioned in the thoracic region of the spine. As a person rolls or shifts their weight from side to side, the massage formations 20 massage the erector spinae muscles on each side of the vertebral column. FIG. 19 shows in particular how the massage formations engage the various muscle groups in the back.

FIG. 20 is a schematic side view of a person 200 using the massage device 10 of FIG. 18 with the device in a slightly different position along the back to that in FIG. 18. In FIG. 20, one end 11 of the device 10 is positioned in the cervical region and the other end 13 is in the thoracic region. That is, it is positioned further up the user's back.

FIG. 21 shows the device 10 in a similar position to that shown in FIG. 18. It also shows the device 10 in a further or second position moved substantially higher up the back of the user 200 with some of the massage formations positioned beneath the user's head. In FIG. 21, the user's arms are raised to apply more pressure to the muscles near the upper end of the device.

FIG. 22 shows the massage device 10 being used with a long axis of the device extending transverse to the vertebral column. Thus, the massage device 10 is arranged transverse to the spine rather than parallel to the spine as in the earlier embodiment. The effect of arranging the device in this manner on the back of the user is that the person's weight is applied to or borne by fewer projections of the massage device. As the weight is applied across a smaller area the pressure applied to the muscles by each massage formation is correspondingly greater. This therefore applies a deeper massage to the muscles of the user.

FIG. 23 shows the massage device arranged in a transverse orientation as in FIG. 22. In FIG. 23, the massage device is positioned higher up on the back of the user when compared with FIG. 22. FIG. 25 shows a person's vertebral column and associated muscle groups and how the transversely arranged massage device 10 interacts with these muscle groups.

FIG. 24 shows a person 200 using the massage device 10 extending transverse to their vertebral column with their arms raised and their hands behind their head. When using the device in this fashion, the user rolls from side to side and this in turn varies the pressure applied by the different massage formations.

FIGS. 26 and 27 also show the massage device 10 extending transverse to the user's vertebral column. The user 200 rolls their body from one side to another. The user can also lie stationary on one side for some time and then do the same on the other side.

A working advantage of the massage device described above with reference to the drawings is that it is particularly capable of effective massage of the back of a user. In particular, it is very good at treating pain caused by back spasm. Yet further, it is designed to be used by the user receiving the massage and it effectively uses the weight of the user's body to apply the pressure needed for effective massage.

The correct application of pressure to be applied with pressure point therapy is important. Too little pressure and/or pressed for too short a time may be therapeutically ineffective. Too much pressure or sustained pressure may cause bruising to the muscle. It is also important to correctly locate the trigger point and to know how to tailor movement to assist in purging lactic acid from muscles. Correct application of pressure point therapy can only be practiced by a skilled masseuse with the appropriate training in pressure point technique.

For example, to be able to apply an effective massage requires a good understanding of the underlying anatomy and physiology of muscles, how the muscle system works, surrounding structures such as tendons, nerves and ligaments and how to recognize and treat the underlying cause of the problem.

It will be appreciated that prior art self-treatment devices and methods that are user controlled cannot attain the skill of a trained masseuse.

The shape and height of the body of the massage formations on the disclosed massage device is designed to mimic the thumbs of an experienced masseuse when applying sustained deep pressure on the deeper layers of muscles and the fascia. The methods of use as described herein mimics the sustained movements that knead and stretch muscle and soft tissue in multiple directions.

The configuration, number and spacing of the massage formations on the base are designed to provide the correct degree of pressure and spacing to optimize the full area that is being massaged required for treatment. Inexperienced user's typically only massage the painful area, whereas the surrounding area must also be massaged.

It will be appreciated that use of the disclosed massage device as described herein can allow a user with no experience whatsoever in massage to self-treat in a therapeutic manner.

A further advantage is that the massage device is compact and can easily be carried in a bag. Further, it can be used in any location there is a horizontal support surface such as a floor. It can also be made cost effectively as an integral article by injection molding.

It will of course be realized that the above has been given only by way of illustrative example of the invention and that all such modifications and variations thereto, as would be apparent to persons skilled in the art, are deemed to fall within the broad scope and ambit of the invention as is herein set forth.

1. A massage device for massaging a user, comprising:
a base having a mounting surface and an opposed massage formation surface;
one row of massage formations projecting up from the massage formation surface extending along the base; and
a further row of massage formations projecting up from the massage formation surface extending along the base, wherein said one row and said further row of massage formations extend parallel to each other and are laterally spaced apart from each other a distance suitable for engaging the erector spinae muscle groups on either side of the vertebral column of the user.

2. A massage device according to claim 1, wherein each of said one row and said further row of massage formations includes from four to eight massage formations.

3. A massage device according to claim 1, wherein the massage formations of each of said one row and said further row have a base having a circular cross-sectional area having a central axis and a center and the circular cross sectional area has a diameter of 25 to 40 mm.

5. A massage device according to claim 1, wherein said one row of massage formations has the same number of massage formations as said further row of massage formations, wherein each of the massage formations in said one row is laterally aligned with its associated massage formation in said further row.

6. A massage device according to claim 5, wherein the centers of adjacent massage formations in said one row and said further row are spaced a distance of 70 to 80 mm apart from each other and the centers of the massage formations in said one row are spaced a lateral distance of 70 to 80 mm away from the massage formations in said further row.

7. A massage device according to claim 1, wherein each massage formation includes:
a cylindrical portion extending away from the base of the massage formation;
a rounded free end portion remote from the base; and
a tapering portion extending between the cylindrical portion and the rounded free end portion.

8. A massage device according to claim 7, the rounded free end portion includes a part spherical section having a radius of curvature of from 10 to 20 mm.

9. A massage device according to claim 7, wherein the free end of each massage formation extends to a height of between 25 mm to 50 mm above the massage formation surface and also above the base of the massage formation.

10. A massage device according to claim 1, wherein each massage formation includes:
a free end portion remote from the base; and
a prolate spheroid portion extending away from the frustoconical portion between the frustoconical portion and the free end, the prolate spheroid portion having a major axis and a polar region, wherein the major axis of the prolate spheroid portion is co-axial with the center axis of the frustoconical portion and the free end portion is at the pole region of the prolate spheroid.

11. A massage device according to claim 1, wherein the base of the massage device is substantially rectangular and extends across said one and further rows of massage formations with a small clearance at each end of each row of massage formations and a small clearance along each side of each massage formation.

12. A massage device according to claim 11, wherein the base of the massage device has an upper solid part that bears the upper massage formation surface and a lower structured part that forms the lower mounting surface.

13. A massage device according to claim 12, wherein the lower structured part comprises a first set of longitudinally extending support rib formations and a second set of laterally extending support rib formations, wherein in use the support rib formations engage a support surface.

14. A massage device according to claim 13, wherein each massage formation is hollow with an internal space and an opening that extends through the upper solid part of the base and terminates in an open circular support wall that in use engages a support surface.

15. A massage device according to claim 14, wherein at least one of said first set of support formations and at least one of said second set of support formations intersect a circular support wall.

16. A massage device according to claim 1, wherein the base is substantially rigid and has no flexibility or minimal flexibility, and the massage formations are also substantially rigid and, wherein the base and the massage formations are integrally formed by means of injection molding.

17. A method of massaging a user's body, the method including:
placing a part of the user's body on a massage device according to claim 1, with the weight of the user's body causing one or more of the massage formations to bear against the part of the user's body to apply a pressure to the part of the user through the massage formations which effects a massage.

18. A method of massaging according to claim 17, wherein the part of the body that is massaged is the back and the massage device is arranged with said one row and said further row of massage formations extending substantially parallel and to either side of the user's vertebral column.

19. A method of massaging a user's body according to claim 18, wherein the massage formations apply pressure to the lumbar and thoracic regions of a user's vertebral column.

20. A method of massaging a user's body according to claim 19, further include the user moving on the massage formations so as to massage the part of the person's body, wherein said moving on the massage formations includes rolling or pivoting the body on the massage formations from one side to the other and, wherein said moving on the massage formations includes to and fro movement in the longitudinal direction of the user's body.
